(19) United States
(12) Patent Application Publication
(10) Pub. No.: US 2026/0274745 A1
(43) Pub. Date: Sep. 17, 2026

(54) COATED GLASS ARTICLE

(71) Applicant: Pilkington Group Limited, Lathom (GB)

(72) Inventors: John William OLDFIELD, St Helens (GB); Jack BROWN, Liverpool (GB); Deborah RAISBECK, Burscough (GB); Peter HARRIS, Chester (GB)

(73) Assignee: Pilkington Group Limited, Lathom (GB)

(21) Appl. No.: 19/166,187

(22) PCT Filed: Mar. 27, 2024
(86) PCT No.: PCT/GB2024/050844

§ 371 Date: Sep. 17, 2025

(30) Foreign Application Priority Data
Mar. 29, 2023 (GB) 2304625.3

(51) Int. Cl. C03C 17/34

(52) U.S. Cl. CPC C03C 17/3417; C03C 2217/94

(57) ABSTRACT

A coated glass article includes a transparent glass substrate and a coating located on the glass substrate. The coating includes at least the following layers in sequence starting from the glass substrate: a first layer based on tin dioxide, a second layer based on an oxide of silicon, and a third layer based on an oxide of iron.

This invention relates to a coated glass article and its use.

It is desirable for certain architectural, automotive and container applications to utilise glass articles that afford solar control and/or UV blocking properties by attenuation of UV and visible light and solar energy transmitted through the glass. It can also be attractive in such applications to provide a glass article that exhibits a bronze colouration in transmission.

Currently such a colouration is generally achieved by changing the composition of the glass to lend it a tint, known as body-tinting. This is achieved by small additions of metal oxides to a float or rolled glass composition which can colour the glass bronze, green, blue or grey but do not affect the basic properties of the glass except for changes in the solar energy transmittance.

However, the use of body-tinted glass is not desirable from a manufacturing standpoint because production of the glass requires the gradual introduction of the tint at the start of a campaign to ensure that the correct level of tint is achieved. Furthermore, when the campaign has finished it takes a significant amount of time for the glass produced on the line to revert to the non-tinted form. These factors result in increased wastage, lost production time and reduced flexibility since it is desirable to conduct as few of these campaigns as possible.

Therefore it would be beneficial to provide a product that possesses the advantageous properties provided by body-tinted glass but that also avoids the aforementioned processing disadvantages.

According to a first aspect of the present invention there is provided a coated glass article comprising:
a transparent glass substrate, and
a coating located on the glass substrate,
wherein the coating comprises at least the following layers in sequence starting from the glass substrate:
a first layer based on tin dioxide,
a second layer based on an oxide of silicon, and
a third layer based on an oxide of iron.

Surprisingly it has been found that the coated glass article according to the first aspect affords the desired solar control and UV blocking properties, alongside a superior bronze colouration.

In the context of the present invention, where a layer is said to be “based on” a particular material or materials, this means that the layer predominantly consists of the corresponding said material or materials, which means typically that it comprises at least about 50 at. % of said material or materials.

In the following discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

In the context of the present invention a transparent material or a transparent substrate is a material or a substrate that is capable of transmitting visible light so that objects or images situated beyond or behind said material can be distinctly seen through said material or substrate.

In the context of the present invention the “thickness” of a layer is, for any given location at a surface of the layer, represented by the distance through the layer, in the direction of the smallest dimension of the layer, from said location at a surface of the layer to a location at an opposing surface of said layer.

In the context of the present invention a “derivative” is a chemical substance related structurally to another chemical substance and theoretically derivable from it.

It should be noted that the refractive index values described herein are reported as average values across 400-780 nm of the electromagnetic spectrum.

In the context of the present invention the “film side” of the transparent glass substrate means a major surface of the glass substrate upon which the coating is located. In the context of the present invention the “glass side” of the transparent glass substrate means a major surface of the glass substrate opposing the major surface upon which the coating is located.

Preferably the coating is located on a first major surface of the glass substrate. The first layer may be in direct contact with the glass substrate. Preferably the first layer is in direct contact with the second layer. Preferably the second layer is in direct contact with the third layer.

Preferably the coated glass article further comprises a lower base layer having a refractive index of more than 1.6, wherein said lower base layer is located between the glass substrate and the first layer. Preferably the coated glass article further comprises an upper base layer having a refractive index that is less than the refractive index of the lower base layer, wherein said upper base layer is located between the lower base layer and the first layer. Preferably the lower base layer is in direct contact with the glass substrate. Preferably the lower base layer is in direct contact with the upper base layer. Preferably the upper base layer is in direct contact with the first layer.

Preferably the first layer is in direct contact with the second layer. Preferably the second layer is in direct contact with the third layer.

Preferably the coating consists of the lower base layer, the upper base layer, the first layer, the second layer and the third layer.

Preferably the lower base layer has a thickness of at least 5 nm, more preferably at least 10 nm, even more preferably at least 12 nm, most preferably at least 13 nm, but preferably at most 35 nm, more preferably at most 25 nm, even more preferably at most 20 nm, most preferably at most 15 nm.

Preferably the upper base layer has a thickness of at least 10 nm, more preferably at least 15 nm, even more preferably at least 20 nm, most preferably at least 25 nm, but preferably at most 50 nm, more preferably at most 40 nm, even more preferably at most 35 nm, most preferably at most 30 nm.

Preferably the first layer has a thickness of at least 140 nm, more preferably at least 150 nm, even more preferably at least 160 nm, most preferably at least 170 nm, but preferably at most 300 nm, more preferably at most 260 nm, even more preferably at most 230 nm, most preferably at most 200 nm.

Preferably the second layer has a thickness of at least 0.5 nm, more preferably at least 1 nm, even more preferably at least 3 nm, most preferably at least 5 nm, but preferably at most 25 nm, more preferably at most 20 nm, even more preferably at most 15 nm, most preferably at most 10 nm.

Preferably the third layer has a thickness of at least 0.5 nm, more preferably at least 5 nm, even more preferably at least 10 nm, most preferably at least 15 nm, but preferably at most 50 nm, more preferably at most 45 nm, even more preferably at most 40 nm, most preferably at most 35 nm.

Preferably the lower base layer has a refractive index of 1.8 or more. More preferably the lower base layer has a refractive index of from 1.8 to 2.5. Even more preferably the lower base layer has a refractive index of from 1.8 to 2.2.

Preferably the lower base layer is based on an oxide of a metal, more preferably the lower base layer is based on tin dioxide, niobium oxide, titanium dioxide, SiCO or tantalum oxide. Preferably, when the lower base layer is based on tin dioxide, niobium oxide, titanium dioxide or tantalum oxide, the upper base layer is present. Preferably, when the lower base layer is based on SiCO, the upper base layer is not present. Most preferably the lower base layer is based on tin dioxide. In certain embodiments, the lower base layer may consist essentially of tin dioxide. Preferably the lower base layer consists of tin dioxide. Preferably the lower base layer is undoped.

Preferably the upper base layer has a refractive index of 1.6 or less. More preferably the upper base layer has a refractive index of from 1.2 to 1.6. Even more preferably the upper base layer has a refractive index of from 1.2 to 1.5.

Preferably the upper base layer is based on an oxide of a metalloid, more preferably the upper base layer is based on silicon dioxide or silicon oxynitride. Most preferably the upper base layer is based on silicon dioxide. In certain embodiments, the upper base layer may consist essentially of silicon dioxide. Preferably the upper base layer consists of silicon dioxide. Preferably the upper base layer is undoped. Preferably the 20 second layer is present.

Preferably the first layer is based on doped tin dioxide. More preferably the first layer is based on tin dioxide doped with antimony, niobium and/or neodymium. Even more preferably the first layer is based on tin dioxide doped with antimony. Even more preferably the first layer consists essentially of tin dioxide doped with antimony. Even more preferably the first layer consists of tin dioxide doped with antimony.

Preferably for the first layer based on tin dioxide doped with antimony, niobium and/or neodymium, preferably doped with antimony, the dopant is present in an amount of at least 1.0 at %, more preferably at least 1.5 at %, even more preferably at least 2.0 at %, most preferably at least 2.5 at %, but preferably at most 10.0 at %, more preferably at most 5.0 at %, even more preferably at most 3.5 at %, most preferably at most 3.0 at %.

Preferably the second layer is based on silicon dioxide, although other stoichiometries may be used. More preferably the second layer consists essentially of silicon dioxide. Even more preferably the second layer consists of silicon dioxide.

Preferably the third layer is based on an oxide of iron (III). Preferably the third layer is based on Fe₂O₃. Preferably the third layer consists essentially of Fe₂O₃. Preferably the third layer consists of Fe₂O₃.

Preferably the coated glass article comprises:
a transparent glass substrate, and
a coating located on the glass substrate,
wherein the coating comprises at least the following layers in sequence starting from the glass substrate:
a first layer based on tin dioxide doped with antimony,
a second layer based on silicon dioxide, and
a third layer based on Fe₂O₃.

More preferably the coated glass article comprises:
a transparent glass substrate, and
a coating located on the glass substrate,
wherein the coating comprises at least the following layers in sequence starting from the glass substrate:
a first layer based on tin dioxide doped with antimony, wherein the first layer has a thickness of at least 150 nm and at most 300 nm,
a second layer based on silicon dioxide, wherein the second layer has a thickness of at least 0.5 nm and at most 20 nm, and
a third layer based on Fe₂O₃, wherein the third layer has a thickness of at least 0.5 nm and at most 50 nm.

For the immediately preceding two paragraphs, preferably the coating consists of the first layer, the second layer and the third layer.

In some embodiments preferably the coated glass article comprises:
a transparent glass substrate, and
a coating located on the glass substrate,
wherein the coating comprises at least the following layers in sequence starting from the glass substrate:
a lower base layer based on tin dioxide,
an upper base layer based on silicon dioxide,
a first layer based on tin dioxide doped with antimony,
a second layer based on silicon dioxide, and
a third layer based on Fe₂O₃.

More preferably the coated glass article comprises:
a transparent glass substrate, and
a coating located on the glass substrate,
wherein the coating comprises at least the following layers in sequence starting from the glass substrate:
a lower base layer based on tin dioxide, wherein the lower base layer has a thickness of at least 5 nm and at most 30 nm,
an upper base layer based on silicon dioxide, wherein the upper base layer has a thickness of at least 10 nm and at most 40 nm,
a first layer based on tin dioxide doped with antimony, wherein the first layer has a thickness of at least 150 nm and at most 300 nm,
a second layer based on silicon dioxide, wherein the second layer has a thickness of at least 0.5 nm and at most 20 nm, and
a third layer based on Fe₂O₃, wherein the third layer has a thickness of at least 0.5 nm and at most 50 nm.

For the immediately preceding two paragraphs, preferably the coating consists of the lower base layer, the upper base layer, the first layer, the second layer and the third layer.

In some embodiments the coated glass article may further comprise a fourth layer based on titanium dioxide, preferably wherein the fourth layer is photocatalytic. Preferably the third layer is in direct contact with the fourth layer. Preferably the fourth layer is located further from the glass substrate than the third layer. Preferably the fourth layer has a thickness of at least 5 nm, more preferably at least 10 nm, even more preferably at least 13 nm, most preferably at least 15 nm, but preferably at most 30 nm, more preferably at most 25 nm, even more preferably at most 22 nm, most preferably at most 20 nm.

Any of the lower base layer, upper base layer, first layer, second layer, third layer and fourth layer may also comprise other constituents including a trace amount or more of other elements such as, for example, carbon. As used herein, the phrase “trace amount” is an amount of a constituent of a coating layer that is not always quantitatively determinable because of its minuteness.

All transmittance, reflectance and colour (a* and b*) values mentioned in this specification are according to the CIELAB colour scale system using Illuminant D65, ten degree observer.

Preferably the coated glass article exhibits a maximum visible light transmittance of 60%, more preferably a maximum visible light transmittance of 50%, more preferably a maximum visible light transmittance of 45%, most preferably a maximum visible light transmittance of 40%, but preferably a minimum visible light transmittance of 10%, more preferably a minimum visible light transmittance of 15%, more preferably a minimum visible light transmittance of 20%, most preferably a minimum visible light transmittance of 25%.

Preferably the coated glass article exhibits a maximum visible light film side reflectance of 40%, more preferably a maximum visible light film side reflectance of 30%, even more preferably a maximum visible light film side reflectance of 20%, most preferably a maximum visible light film side reflectance of 15%, but preferably a minimum visible light film side reflectance of 2%, more preferably a minimum visible light film side reflectance of 5%, more preferably a minimum visible light film side reflectance of 8%, most preferably a minimum visible light film side reflectance of 10%.

Preferably the coated glass article exhibits a maximum visible light glass side reflectance of 25%, more preferably a maximum visible light glass side reflectance of 20%, even more preferably a maximum visible light glass side reflectance of 15%, most preferably a maximum visible light glass side reflectance of 10% but preferably a minimum visible light glass side reflectance of 2%, more preferably a minimum visible light glass side reflectance of 4%, more preferably a minimum visible light glass side reflectance of 6%, most preferably a minimum visible light glass side reflectance of 8%.

Preferably the coated glass article exhibits a maximum Total Solar Energy Transmittance or G-value of 0.7, more preferably a maximum G-value of 0.6, more preferably a maximum G-value of 0.5, most preferably a maximum G-value of 0.45.

Preferably the coated glass article exhibits an a* coordinate in reflection on the film side of at least −15, more preferably at least −10, even more preferably at least −5, but preferably at most 5, more preferably at most 0, even more preferably at most −2.

Preferably the coated glazing exhibits a b* coordinate in reflection on the film side of at least −15, more preferably at least −10, even more preferably at least −5, but preferably at most 5, more preferably at most 0, even more preferably at most −1.

Preferably the coated glazing exhibits an a* coordinate in reflection on the glass side of at least −10, more preferably at least −5, even more preferably at least −3, but preferably at most 5, more preferably at most 2, even more preferably at most 0.

Preferably the coated glazing exhibits a b* coordinate in reflection on the glass side of at least −15, more preferably at least −10, even more preferably at least −5, but preferably at most 5, more preferably at most 0, even more preferably at most −4.

Preferably the coated glazing exhibits an a* coordinate in transmission of at least 0, more preferably at least 5, even more preferably at least 10, but preferably at most 20, more preferably at most 15, even more preferably at most 12.

Preferably the coated glazing exhibits a b* coordinate in transmission of at least 5, more preferably at least 10, even more preferably at least 15, but preferably at most 30, more preferably at most 25, even more preferably at most 20.

Preferably, when the coated glass article further comprises a fourth layer based on titanium dioxide, the coating has a specific photocatalytic activity in accordance with ISO/DIS 10678:2010 of greater than 0.4 nmol/cm²h, more preferably greater than 0.5 nmol/cm²h, even more preferably greater than 0.6 nmol/cm²h, even more preferably greater than 0.7 nmol/cm²h, most preferably greater than 0.8 nmol/cm²h.

Preferably the coating has a photocatalytic activity in accordance with EN 1096-5:2011 represented by a mean global change of haze of up to 3%, more preferably up to 2%, even more preferably up to 1.5%, most preferably up to 1%.

Preferably the transparent glass substrate is a transparent glass sheet. Preferably the transparent glass sheet is flat, or alternatively the transparent glass sheet is curved. In some alternative embodiments the transparent glass substrate is a transparent glass container, for example the transparent glass container is a bottle, vial, tube, canister or jar.

The transparent glass substrate may be clear or tinted. Preferably the transparent glass substrate is a clear transparent glass substrate. The transparent glass substrate may be a metal oxide-based glass pane. The glass pane may be a clear or tinted float glass pane. Preferably the glass pane is a clear glass pane. A typical soda-lime-silicate glass composition is (by weight), SiO₂ 69-74%; Al₂O₃ 0-3%; Na₂O 10-16%; K₂O 0-5%; MgO 0-6%; CaO 5-14%; SO₃ 0-2% and Fe₂O₃ 0.005-2%. The glass composition may also contain other additives, for example, refining aids, which would normally be present in an amount of up to 2%. By clear float glass, it is meant a glass having a composition as defined in BS EN 572-1 and BS EN 572-2 (2004). For clear float glass, the Fe₂O₃ level by weight is typically 0.11%. Float glass with an Fe₂O₃ content less than about 0.05% by weight is typically referred to as low iron float glass. Such glass usually has the same basic composition of the other component oxides i.e. low iron float glass is also a soda-lime-silicate glass, as is clear float glass. Typically tinted float glass has at least 0.5% by weight Fe₂O₃, e.g. 1.0% by weight Fe₂O₃. Alternatively the glass pane is a borosilicate-based glass pane, an alkali-aluminosilicate-based glass pane, or an aluminium oxide-based crystal glass pane.

Preferably, in use, the first major surface of the glass substrate on which the coating may be located faces away from a building in which it has been installed, i.e. the first major surface of the glass substrate may face the external environment and would commonly be named surface #1.

In certain embodiments the coated glass article may further comprise a second coating located on an opposing major surface of the glass substrate, i.e. the coating referred to in the preceding paragraphs is located on a first major surface of the glass substrate and the second coating is located on the opposing major surface of the glass substrate. The second coating may comprise an antireflection, low-emissivity and/or solar control coating. Preferably, in use, the first major surface (surface #1) of the glass substrate faces away from a building in which it has been installed and the opposing major surface (surface #2) of the glass substrate faces towards said building in which it has been installed.

In some embodiments an opposing major surface of the glass substrate may be bonded to a second glass substrate by a ply of plastics interlayer. Preferably the plastics interlayer comprises polyvinyl butyral or PVB. Any of the opposing major surface of the glass substrate and either surface of the second glass substrate may be coated, for example with an antireflection, low-emissivity and/or solar control coating.

In particular embodiments the coated glass article of the first aspect, e.g. the coated glass article of the two immediately preceding paragraphs, may be combined with further glass substrates (e.g. one or two further glass substrates) to form a glazing unit.

The coated glass article may be held in a spaced apart relationship with any adjacent further glass substrate to form an insulated glazing unit. Any further glass substrate may be held in a spaced apart relationship with any adjacent further glass substrate to form an insulated glazing unit.

According to a second aspect of the present invention there is provided the use of the coated glass article of the first aspect to provide solar control and/or UV blocking properties. Preferably said use occurs in architectural or automotive applications.

According to a third aspect of the present invention there is provided a process for manufacturing the coated glass article according to the first aspect, said process comprising:
providing a glass substrate having a surface, and depositing a coating according to the first aspect on the surface of the glass substrate.

Preferably the coating is deposited by chemical vapour deposition (CVD), a physical vapour deposition process, such as sputtering, a sol-gel process or another solution-based process. Most preferably the coating is deposited by CVD.

Any feature set out above in relation to the first aspect of the present invention may also be utilised in relation to any other aspects of the present invention.

Any invention described herein may be combined with any feature of any other invention described herein mutatis mutandis.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention will now be further described by way of the following specific embodiments, which are given by way of illustration and not of limitation, with reference to the accompanying drawing in which:

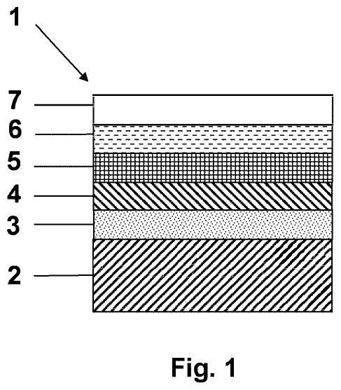

FIG. 1 is a schematic view, in cross-section, of a coated glass article in accordance with certain embodiments of the present invention, and

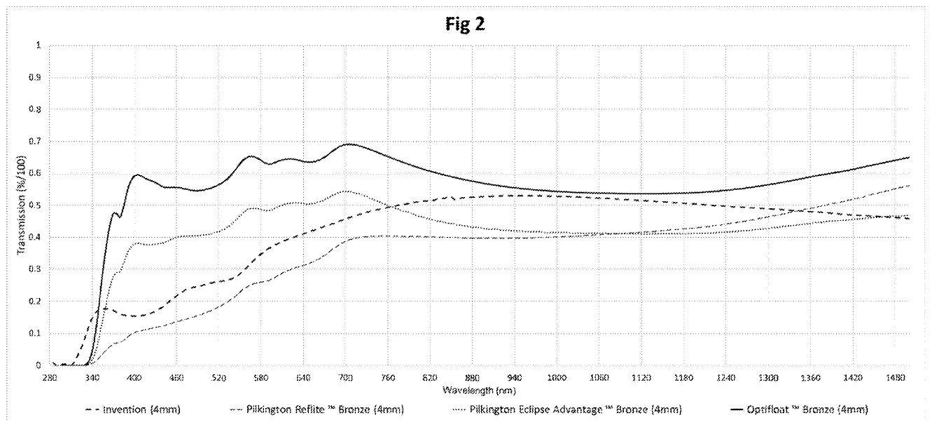

FIG. 2 shows transmission spectra for a coated glass article in accordance with certain embodiments of the present invention and comparative coated glass articles.

FIG. 1 shows a cross-section of a coated glass article 1 according to certain embodiments of the present invention. Coated glass article 1 comprises a transparent float glass substrate 2 that has been sequentially coated using CVD with a layer based on tin dioxide 3, a layer based on silicon dioxide 4, a layer based on antimony doped tin oxide 5, a layer based on silicon dioxide 6 and a layer based on Fe₂O₃ 7. The CVD may be carried out in conjunction with the manufacture of the glass substrate in the float glass process.

### EXAMPLE

An example according to the invention was prepared using atmospheric pressure CVD on a dynamic coater. The transparent glass substrate used was clear soda-lime-silica glass with a thickness of 4 mm.

The coating for the example consisted of the following five layers starting from the glass substrate: SnO₂/SiO₂/SnO₂: Sb/SiO₂/Fe₂O₃.

The SnO₂ layer was deposited over the glass surface using the following components:
N₂ carrier gas, O₂, dimethyltin dichloride, and H₂O.

The SiO₂ layers were deposited over the glass surface using the following components:
N₂ carrier gas, He carrier gas, O₂, C₂H₄, and SiH₄.

The SnO₂: Sb layer was deposited over the glass surface using the following components:
N₂ and He carrier gas, O₂, dimethyltin dichloride, 30-50 wt % triphenyl antimony in ethyl acetate, and H₂O.

The Fe₂O₃ layer was deposited over the glass surface using the following components:
Ferrocene, O₂ and N₂ carrier gas.

The optical properties of the resultant coated glazing were determined using a HunterLab™ Ultrascan Pro spectrophotometer. The layer thicknesses of the Examples were determined by scanning electron microscopy (SEM) using an FEI Nova NanoSEM™ 450 and EDAX Octane plus EDS detector with TEAM software. The optical properties and layer thicknesses of the Example are shown below in Tables 1 and 2:

TABLE 1
Optical properties for Example according to the invention

| Transmittance | | | Film Side Reflectance | | | Glass Side Reflectance | | |
|---|---|---|---|---|---|---|---|---|
| % | a* | b* | % | a* | b* | % | a* | b* |
| 30.9 | 11.1 | 18.4 | 33.1 | −11.8 | −3.3 | 9.6 | −2.5 | −8.6 |

TABLE 2
Layer thicknesses for Example according to the invention
Layer Thicknesses (nm)

| SnO₂ | SiO₂ | SnO₂:Sb | SiO₂ | Fe₂O₃ |
|---|---|---|---|---|
| 14.1 | 28.3 | 201.4 | 10.3 | 20.0 |

The example according to the invention was compared with three commercially available products that utilise tinted glass to provide a bronze colouration. Pilkington Reflite™ Bronze, Pilkington Eclipse Advantage™ Bronze and Optifloat™ Bronze commercially available products of 4 mm thickness were compared with the example to ascertain their relative UV blocking characteristics.

FIG. 2 shows that the example according to the invention (labelled invention (4 mm)) exhibits superior UV blocking capability (see the region from 280-400 nm) compared with both Pilkington Eclipse Advantage™ Bronze and Optifloat™ Bronze, despite the fact that the example does not comprise tinted glass. Furthermore, the example according to the invention also affords an acceptable level of visible light transmission.

The invention is not restricted to the details of the foregoing embodiments. The invention extends to any novel one, or any novel combination, of the features disclosed in this specification (including any accompanying claims, abstract and drawings), or to any novel one, or any novel combination, of the steps of any method or process so disclosed.

1.-16. (canceled)

17. A coated glass article comprising:
a transparent glass substrate, and
a coating located on the glass substrate,
wherein the coating comprises at least the following layers in sequence starting from the glass substrate:
a first layer based on tin dioxide,
a second layer based on an oxide of silicon, and
a third layer based on an oxide of iron.

18. The coated glass article according to claim 17, wherein the coated glass article further comprises a lower base layer having a refractive index of more than 1.6, and wherein said lower base layer is located between the glass substrate and the first layer.

19. The coated glass article according to claim 18, wherein the coated glass article further comprises an upper base layer having a refractive index that is less than the refractive index of the lower base layer, and wherein said upper base layer is located between the lower base layer and the first layer.

20. The coated glass article according to claim 19, wherein the lower base layer is in direct contact with the glass substrate, wherein the lower base layer is in direct contact with the upper base layer, wherein the upper base layer is in direct contact with the first layer, wherein the first layer is in direct contact with the second layer, and wherein the second layer is in direct contact with the third layer.

21. The coated glass article according to claim 19, wherein the coating consists of the lower base layer, the upper base layer, the first layer, the second layer and the third layer.

22. The coated glass article according to claim 17, wherein the first layer has a thickness of at least 140 nm, but at most 300 nm.

23. The coated glass article according to claim 17, wherein the second layer has a thickness of at least 0.5 nm, but at most 25 nm.

24. The coated glass article according to claim 17, wherein the third layer has a thickness of at least 0.5 nm, but at most 50 nm.

25. The coated glass article according to claim 19, wherein the lower base layer is based on tin dioxide, and wherein the upper base layer is based on silicon dioxide.

26. The coated glass article according to claim 17, wherein the first layer is based on tin dioxide doped with antimony, niobium and/or neodymium.

27. The coated glass article according to claim 17, wherein the first layer is based on tin dioxide doped with antimony.

28. The coated glass article according to claim 17, wherein the second layer is based on silicon dioxide.

29. The coated glass article according to claim 17, wherein the third layer is based on an oxide of iron (III).

30. The coated glass article according to claim 17, wherein the third layer is based on Fe₂O₃.

31. The coated glass article according to claim 17, wherein the coated glass article further comprises a fourth layer based on titanium dioxide, wherein the third layer is in direct contact with the fourth layer and the fourth layer is located further from the glass substrate than the third layer.

32. A coated glass article comprising:
a transparent glass substrate, and
a coating located on the glass substrate,
wherein the coating comprises at least the following layers in sequence starting from the glass substrate:
a lower base layer based on tin dioxide, wherein the lower base layer has a thickness of at least 5 nm and at most 30 nm,
an upper base layer based on silicon dioxide, wherein the upper base layer has a thickness of at least 10 nm and at most 40 nm,
a first layer based on tin dioxide doped with antimony, wherein the first layer has a thickness of at least 150 nm and at most 300 nm,
a second layer based on silicon dioxide, wherein the second layer has a thickness of at least 0.5 nm and at most 20 nm, and
a third layer based on Fe₂O₃, wherein the third layer has a thickness of at least 0.5 nm and at most 50 nm.

33. A process for manufacturing the coated glass article according to claim 17, said process comprising:
providing a glass substrate having a surface, and
depositing a coating according to claim 17 on the surface of the glass substrate.
